(19) United States
(12) Patent Application Publication
(10) Pub. No.: US 2012/0303945 A1
(43) Pub. Date: Nov. 29, 2012

(54) COMPUTER SYSTEM WITH MULTIPLE OPERATION MODES AND METHOD OF SWITCHING MODES THEREOF

(75) Inventors: Hou Yuan Lin, New Taipei City (TW); Chen Shun Chen, New Taipei City (TW); Han Yu Kao, New Taipei City (TW)

(73) Assignee: GIGA-BYTE TECHNOLOGY CO., LTD.

(21) Appl. No.: 13/274,347

(22) Filed: Oct. 16, 2011

(30) Foreign Application Priority Data
May 25, 2011 (TW) 100118232

(51) Int. Cl. G06F 9/00

(52) U.S. Cl. 713/100

(57) ABSTRACT

In a computer system with multiple operation modes and a method of switching modes, the computer system switches the operation modes with multiple hard disk drives by a setting signal. The method of switching modes includes the following steps. A chip unit detects the number of the hard disk drives with no storage of the boot program and the chip unit decides the operation mode of the Redundant Array of Independent Disks. The chip unit produces a corresponding control signal and transmits the control signal to a switch unit. The switch unit produces a setting signal according to the control signal and delivers to the hard disk device to switch the operation modes of the hard disk.

This application claims the benefit of the filing date 2011 May 25 of Taiwan Patent Application No. 100118232, filed on, in the Taiwan Intellectual Property Office, the disclosure of which is incorporated herein in its entirety by reference.

### BACKGROUND OF THE INVENTION

1. Field of Invention

The present invention relates to a switchable system and a switch method, more particularly, relates to a computer system with multiple operation modes and the switch method thereof.

2. Related Art

The main function of the hard disk drive of the present computer system is to store up the boot program, operation system and files. Boot procedure starts after turning on the computer, thereafter the computer loads the boot program saved in the hard disk drive and completes the required parameter settings of the boot procedure by the boot program. When turning off the computer, the computer also writes the changes of related setting into the boot program for next boot procedure.

The efficiency of the computer system while turning on/off the computer is highly related to the efficiency of accessing the hard disk drive. In addition, the efficiency of the computer system in normal operation is also dependent on the efficiency of accessing the hard disk drive.

In general, there are two types of hard disk drive for computer system; one is Hard Disk Drive (HDD) and the other is Solid State Drive (SSD).

The structure of the HDD is more complicated than the SSD. The HDD mainly includes the read/write head, the platter, and the spindle motor. The SSD mainly includes the process unit and the storage unit. The process unit electrically connects to the storage unit and the process unit which is able to access the storage unit directly.

The HDD occupies larger space, performs slower data access speed and consumes more power because of its complicated structure. In contrast, the SSD possesses smaller size, higher access speed and less power consumption.

The HDD is more prevalent than the SSD in the present computer system because the memory size of the HDD is larger than the SSD. Additionally, the HDD is also cheaper than the SSD. However, as the computer system processing speed improved, the HDD becomes a bottleneck for both system on/off and data accessing due to its low efficiency.

### SUMMARY OF THE INVENTION

The present invention provides a computer system with multiple operations and a method of switching modes. The present invention improves the efficiency of the hard disk drives while turning on/off the computer and accessing stored data.

The computer system of the present invention includes a plurality of hard disk drives, a chip unit and a switch unit. At least one of the hard disk drives contains a boot program and executes the boot operation normally. The chip unit electrically connects to the hard disk drives. Moreover, the chip unit detects the number of the hard disk drives with no boot program and the chip unit optionally produces a control signal. The switch unit electrically connects to the chip unit and the hard disk drives; the switch unit receives the control signal and produces a setting signal according to the control signal to the hard disk drives. The hard disk drives with no boot program execute an operation mode of the Redundant Array of Independent Disks (RAID).

The method of switching the operation modes includes the following steps. A chip unit detects the number of the hard disk drives with no boot program and decides the operation mode of the Redundant Array of Independent Disks (RAID) of the hard disk drives with no boot program. The chip unit produces a control signal correspondingly and transmits the control signal to a switch unit. The switch unit produces a setting signal to the hard disk drives with no boot program and the hard disk drives with no boot program execute the operation mode of the Redundant Array of Independent Disks (RAID).

The present invention does not only improve the efficiency of general data access by the operation mode of the Redundant Array of Independent Disks (RAID) of the hard disk drives but also promotes the performance of the hard disk drives by substituting the Solid State Drives for the Hard Disk Drives as the storage device. The improved performance of the hard disk drives is not limited to the general data access or turning on/off procedure.

Further objects and advantages are apparent in the drawings and in the detailed description which follows.

### BRIEF DESCRIPTION OF THE DRAWINGS

FIG. 1 illustrates the block chart of the computer system of the present disclosure.

FIG. 2 illustrates the flow chart of the computer system of the present disclosure.

### DETAIL DESCRIPTION OF THE INVENTION

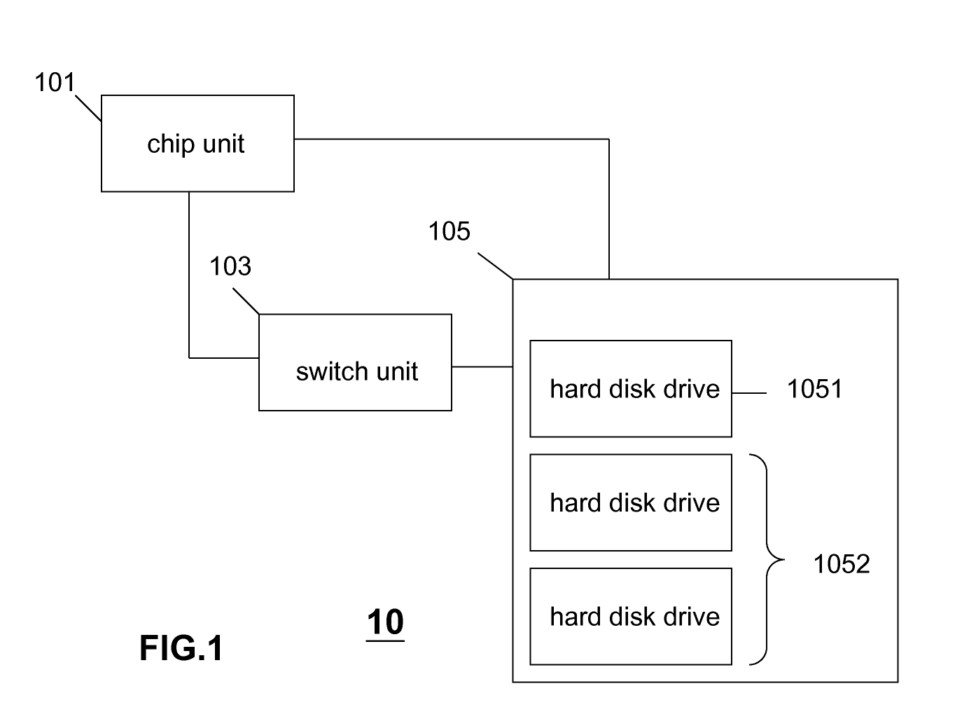

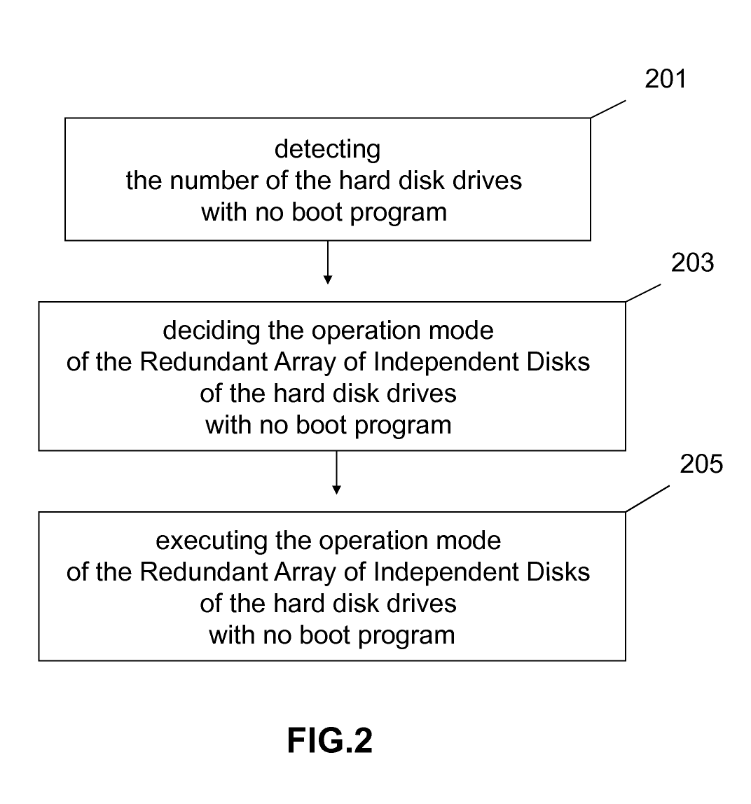

FIG. 1 illustrates the block chart of a computer system and FIG. 2 illustrates the flow chart of a switch method of the computer system of the present invention. This is a preferred embodiment of the present invention.

The computer system 10 of the present invention includes a chip unit 101, a switch unit 103 and a plurality of the hard disk drives 105. The chip unit 101 electrically connects to the hard disk drives 105. The switch unit 103 electrically connects to the chip unit 101 and the hard disk drives 105. At least one hard disk drive 1051 of the hard disk drives 105 contains a boot program and the hard disk drive 1051 executes the boot operation normally.

The hard disk drives 105 of the present invention could be the Hard Disk Drive (HDD) or the Solid State Drive (SSD). However, the type of the hard disk drives 105 of the present invention is not limited to the present embodiment.

The switch unit 103 of the present invention could be a control chip or a General Purpose Input Output (GPIO). However, the type of the switch unit 103 of the present invention is not limited to the present embodiment.

Referring to FIG. 1 and FIG. 2, step 201 describes the process that the chip unit 101 detects the memory space of the hard disk drives 105 to obtain the number of the hard disk drives with no boot program. The detecting process separates the hard disk drives 105 into two parts: at least one hard disk drive 1051 containing the boot program and a plurality of hard disk drives 1052 with no boot program. Simultaneously, the respective count of the hard disk drive 1051 and the hard disk drives 1052 is also obtained.

Referring to FIG. 2, step 203 describes the process that the chip unit 101 decides whether it switches the hard disk drives 1052 to prosecute Redundant Array of Independent Disks (RAID) operation mode according to a mode setting saved in the chip unit 101, and the chip unit 101 also decides the type of the RAID operation mode. The chip unit 101 generates a control signal according to the decision, then transmits the control signal to the switch unit 103.

Referring to FIG. 2, step 205 describes the process that the switch unit 103 receives the control signal and generates a corresponding setting signal in accordance with the control signal. Later on, the switch unit 103 transmits the setting signal to the hard disk drives 1052, which executes the RAID operation mode.

Referring to FIG. 2, the mode setting saved in the chip unit 101 in step 203 could be manipulated by the user under the operation system. The mode setting decides whether the chip unit 101 switches the operation mode to the RAID operation mode or not and it also decides the type of the RAID operation mode. The mode setting is dependent on the count of the hard disk drives 1052 and user's requirement. Thereafter, the chip unit 101 produces the control signal in accordance with the mode setting.

In the other way, referring to step 203 in FIG. 2, the mode setting saved in the chip unit 101 in step 203 could also be manipulated by the user under Basic Input Output System (BIOS). The mode setting decides whether the chip unit 101 switches the operation mode to the RAID operation mode or not, and it also decides the type of the RAID operation mode. The mode setting is dependent on the count of the hard disk drives 1052 and user's requirement. Thereafter, the chip unit 101 produces the control signal corresponding to the mode setting.

The basic feature of the Redundant Array of Independent Disks (RAID) is a combination of multiple hard disk drives and forming a single array of the hard disk drives. A controller of RAID provides various RAID operation modes with better data access and backup performance.

Compared to the single hard disk drive, the RAID is fit to data integration, error detecting and larger memory. Common operation modes of RAID include RAID-0, RAID-1, RAID-1E, RAID-5, RAID-6, RAID-7, RAID-10, and RAID-50. In addition, the computer system configures the RAID as a single disk or a single logic drive because the RAID controller combines multiple hard disk drives together to form a single logic drive.

The operation mode of the RAID of the present invention is not limited to the present embodiment. In fact, there are various combinations of the RAID modes. For example, the RAID 0 mode provides Striping/Span function, and this mode integrates hard disk drives together into one logic drive but separates the data into several parts which are saved in the different hard disk drive respectively. The RAID 0 mode access all partial data at the same time from different hard disk drives. The RAID 0 mode improves the efficiency of data access because it accesses the data from multiple drives at the same time; however, it only operates with no error detection. In common practice, the RAID 0+1 mode combines the RAID 0 and RAID 1 together. The RAID 0+1 mode provides both high efficiency from the RAID 0 mode and the backup function from the RAID 1 mode. But the hard disk drives required by the RAID 0+1 mode must contain at least 4 drives or any even number above 4. The RAID mode of the present invention is decided by the number of the hard disk drives and user's application.

The method of switching the operation modes of the computer system is applicable to the multiple hard disk drives which are with no boot program. If there are hard disk drives with no boot program, the method promotes the performance of the hard disk drives of the computer system by the RAID modes. The method also substitutes the Hard Disk Drives with the Solid State Drives as the storage device to improve the efficiency of the hard disk drives whether it contains the boot program or not.

While the invention has been described in terms of what is presently consider to be the preferred embodiments, it is to be understood that the invention needs not be limited to the disclosed embodiment. On the contrary, it is intended cover various modifications and similar arrangements included within the spirit and scope of the appended claims which are to be accorded with the broadest interpretation so as to encompass all such modification and similar structures. It is therefore intended by the appended claims to define the true scope of the invention.

What is claimed is:

1. A computer system with multiple operation modes, the computer system comprising:
a plurality of hard disk drives, at least one of the hard disk drives containing and executing a boot program normally;
a chip unit electrically connecting to the hard disk drives, the chip unit detecting the number of the hard disk drives stored no boot program, and the chip unit optionally generating a control signal; and
a switch unit electrically connecting to the chip unit and the hard disk drives, the switch unit receiving the control signal and generating a setting signal to the hard disk drives accordingly, and at least two hard disk drives with no boot program being able to execute an operation mode of the Redundant Array of Independent Disks.

2. The computer system of claim 1, wherein the hard disk drive is a Solid State Drive.

3. The computer system of claim 1, wherein the switch unit is a control chip.

4. The computer system of claim 1, wherein the switch unit is a General Purpose Input Output.

5. A method of switching the operation modes of a computer system, the method comprising the following steps:
detecting the number of the hard disk drives with no boot program by a chip unit;
deciding an operation mode of the Redundant Array of Independent Disks of the hard disk drives with no boot program by the chip unit;
generating a control signal, and transmitting the control signal to a switch unit by the chip unit;
receiving the control signal, generating a setting signal correspondingly, and transmitting the setting signal to the hard disk drives by the switch unit; and
executing the operation mode of the Redundant Array of Independent Disks by at least two hard disk drives with no boot program.

6. The method of claim 5 further comprising:
determining the control signal of the chip unit and the operation mode of the Redundant Array of Independent Disks of the hard disk drives by an operation system.

7. The method of claim 5 further comprising the steps of:
determining the control signal of the chip unit and the operation mode of the Redundant Array of Independent Disks of the hard disk drives by a Basic Input Output System.
